(19) United States
(12) Patent Application Publication
(10) Pub. No.: US 2003/0172541 A1
(43) Pub. Date: Sep. 18, 2003

(54) Extension kit for calipers

(76) Inventor: Samuel Jeffery, Kfar Saba (IL)

Correspondence Address: Edward Langer, Shiboleth Yisraeli Roberts Zisman & Company, 60th Floor, 350 Fifth Avenue, New York, NY, 10118, US

(21) Appl. No.: 10/220,082

(22) PCT Filed: Mar. 1, 2001
(86) PCT No.: PCT/IL01/00197

(30) Foreign Application Priority Data
Mar. 1, 2000 (IL) 134815

(51) Int. Cl. G01B 3/18

(52) U.S. Cl. 33/826

(57) ABSTRACT

An extension kit for extending the use of standard calipers to a wide variety of measuring applications not otherwise possible or convenient for such calipers. The calipers include a jaw (3a) slideable along a scaled beam (5) with respect to a fixed jaw (4a). The extension kit included: a first housing (10) attachable to the fixed jaw, a second housing (20) attachable to the slideable jaw, and a plurality of accessories including contact point rods (30) selectively attachable to the first and second housings.

### FIELD AND BACKGROUND OF THE INVENTION

The present invention relates to calipers for measuring various dimensions, and particularly to an extension kit for enabling standard calipers to be used for a wide variety of additional measuring applications not otherwise possible or convenient for such calipers.

Calipers are used for measuring various dimensions. One type includes a jaw slideable with respect to a fixed jaw along a scaled beam indicating the distance between the jaws. This distance may be indicated by graduations on the scaled beam, and/or by a measuring device fixed to the slideable jaw and including a digital or analogue display for displaying the measurement of the distance between the two jaws.

While such known calipers are capable of producing precise measurements, they are generally constructed for measuring distances between elements or surfaces conveniently accessible to the two jaws. However, there are many situations requiring precise measurements of distances between two elements or surfaces which are not conveniently accessible to the caliper jaws.

### OBJECTS AND BRIEF SUMMARY OF THE INVENTION

An object of the present invention is to provide an extension kit for extending the use of calipers of the foregoing type to a wide variety of additional measuring applications wherein the elements or surfaces involved in the measurements are not conveniently accessible to the jaws of a standard calipers.

According to one aspect of the present invention, there is provided an extension kit for extending the use of standard calipers to a wide variety of measuring applications not otherwise possible or convenient for such calipers, which calipers include a slideable jaw slideable along a scaled beam with respect to a fixed jaw, the extension kit comprising: a first housing attachable to the fixed jaw; a second housing attachable to the slideable jaw; and a plurality of accessories including contact point rods selectively attachable to the first and second housings.

According to another aspect of the present invention, there is provided an extension kit for extending the use of calipers to a wide variety of measuring applications, which calipers include a first jaw slideable with respect to a fixed jaw along a scaled bar indicating the distance of the slideable jaw from the fixed jaw; the extension kit including: first and second housings attachable to the slideable and fixed jaws, respectively; and a plurality of contact point rods carrying a variety of contact points at one of their ends; each of the housings having a socket for attaching to its respective caliper jaw, and a horizontal access opening for receiving and clamping a contact point rod (or other suitable accessory); the horizontal access openings of the two housings being located in a wall of the respective housing such that when the two housings are attached via the sockets to their respective jaws, the horizontal access openings are aligned with each other.

According to further features in the preferred embodiment of the invention described below, each housing is also formed with a vertical access opening for receiving and clamping another suitable accessory.

According to further features in the described preferred embodiment, the kit includes a plurality of contact points selectively attachable to the contact point rods. Each of the latter rods is formed with a threaded end for threadedly receiving a selected contact point. Preferably, some of the contact points include tips of needle configuration, and others of ball configuration. Contact points and rods of many other configurations could also be included.

According to still further features in the described preferred embodiment, the kit also includes an alignment compensator comprising a rod at one end receivable in the horizontal or vertical access opening of a housing, a threaded bore at the opposite end for receiving a contact point, and a rotatable ball between the ends for final alignment between the two opposing contact points.

The kit further includes an alignment rod having its opposite ends receivable in the horizontal access openings of the two housings for preliminary alignment of the two housings. Such a kit may include many other accessories, e.g., capacity extenders for increasing or extending the measuring capacity of the calipers.

Further features and advantages of the invention will be apparent from the description below.

### BRIEF DESCRIPTION OF THE DRAWINGS

The invention is herein described, by way of example only, with reference to the accompanying drawings, wherein:

FIG. 1 illustrates one form of conventional digital calipers equipped with a plurality of members of an extension kit constructed in accordance with one embodiment of the present invention;

FIG. 2 illustrates the basic components of an extension kit constructed in accordance with the embodiment of FIG. 1;

FIG. 3 is an exploded perspective view illustrating the construction of one of the housings in the extension kit of FIG. 2;

FIG. 4 is a front view of the housing in FIG. 3;

FIG. 5 is a sectional view along line V-V of FIG. 4;

FIG. 6 is a sectional view illustrating the construction of the alignment compensation member included in the kit of FIG. 2;

FIG. 7 is a front view illustrating a pair of housings mounting one form of contact point rods;

FIG. 8 is a rear view of the housings and contact point rods in FIG. 7;

FIG. 9 is a front view illustrating a pair of housings fitted with an alignment rod;

FIGS. 10a-10t illustrate examples of a wide variety of measuring applications enabled by the extension kit constructed in accordance with the present invention, including a number of other accessories that may be included in the kit, or otherwise available, for such measuring applications;

FIG. 11 illustrates the digital calipers of FIG. 1 but equipped with members of an extension kit construction in accordance with a second embodiment of the present invention;

FIG. 12 illustrates the basic components of the extension kit of the embodiment of FIG. 11;

FIG. 13 is an exploded perspective view illustrating the construction of one of the housings in the extension kit of FIG. 12;

FIG. 14 is a front view of the housing in FIG. 13;

FIG. 15 is a sectional view along line XV-XV of FIG. 14; and

FIG. 16 is a sectional view along line XVI-XVI of FIG. 15.

### DESCRIPTION OF PREFERRED EMBODIMENTS

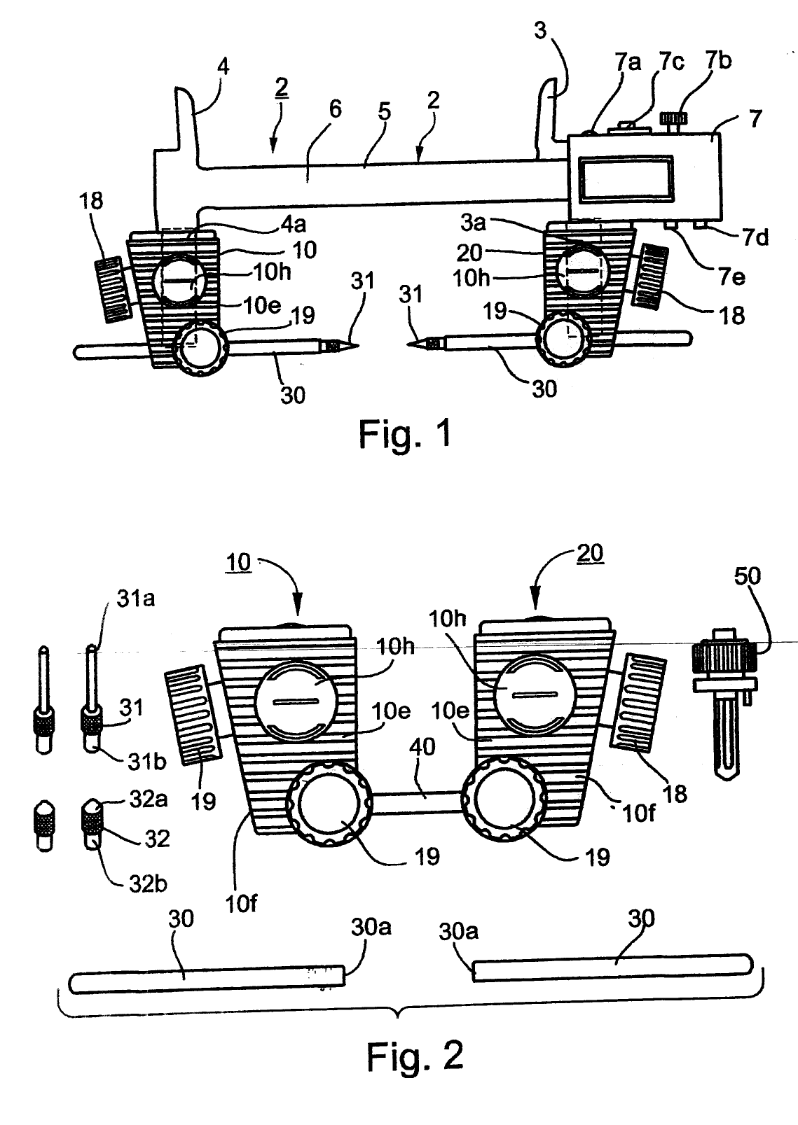

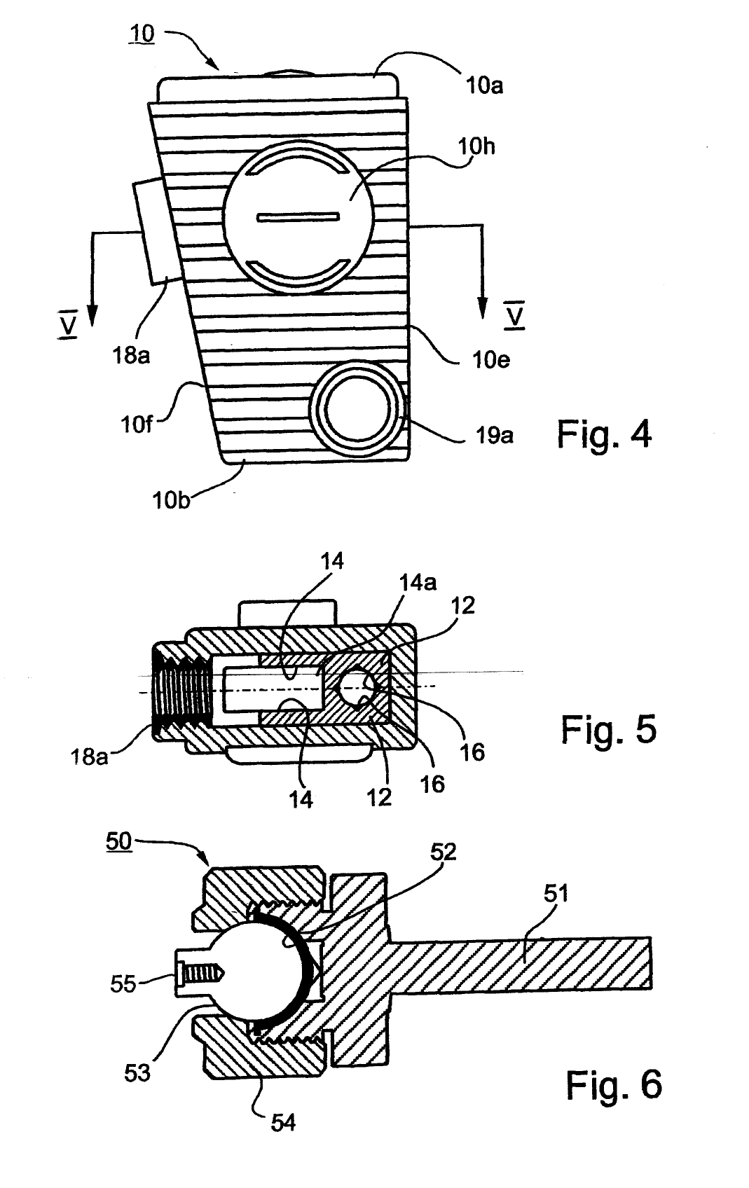

The Kit of FIGS. 1-10t

The extension kit illustrated in FIGS. 1-10t of the drawings is designed for use with many different types of calipers, such as shown at 2 in FIG. 1, including a slideable jaw 3 movable with respect to a fixed jaw 4 along a scaled beam 5. In the calipers illustrated in FIG. 1, the measurement of the distance of jaw 3 from jaw 4 is indicated by graduation markings 6 on scaled beam 5, and also by a measuring device 7 having a digital display 7a mounted on jaw 3 for movement therewith. Measuring device 7 is slideable and lockable on the scaled beam 5 of the calipers by a screw 7b, and includes, in addition to the display 7a, a selector 7c for selecting millimeter or inch measurements, a “zero”-setting button 7d, and an Off-button 7e.

Such calipers are generally provided with an extension 3a fixed to jaw 3 so as to move therewith, and another extension 4a fixed to jaw 4. These enable certain measurements to be made between jaws 3 and 4, or other measurements to be made between their jaw extensions 3a and 4a.

According to the present invention, the two jaw extensions 3a, 4a are used for mounting selected members of the extension kit in order to enable the calipers also to be used for many measuring applications not normally possible or convenient with a conventional calipers.

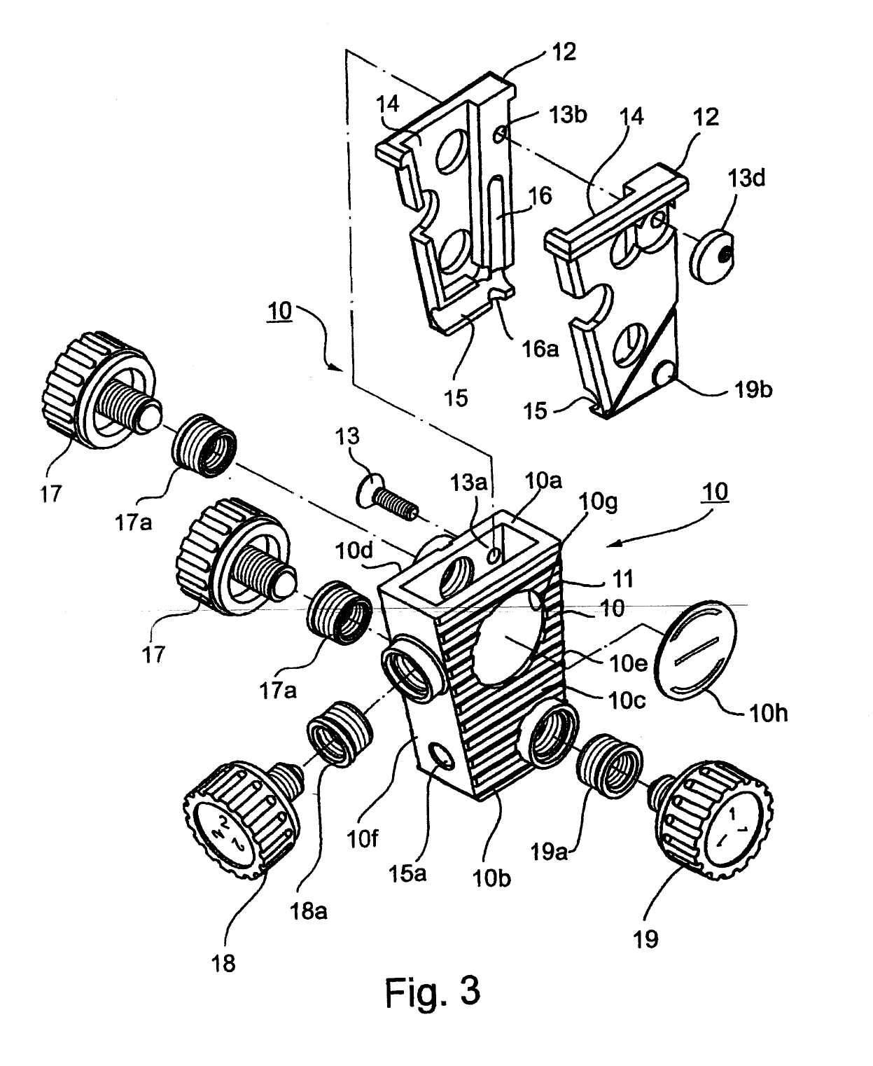

Mounting selected members of the extension kit to the jaws 3 and 4, according to the respective measuring application, is effected by a pair of housings 10 and 20 mounted to the jaw extensions 3a, 4a, respectively. Each housing is adapted to receive a contact point rod 30 (FIG. 2) carrying a selected contact point, as described below. The two housings are of identical construction, except that one is a mirror image of the other. Accordingly, the construction of housing 10 is described below, particularly with respect to the exploded perspective view of FIG. 3, it being appreciated that housing 20 is similarly construction as a mirror image thereof.

As shown in FIG. 3, housing 10 includes an outer hollow section 11 and a pair of inner liners 12 insertable through the open upper end of the outer housing section 11 and fixed within it by a screw 13. Screw 13 passes through an opening 13a in the outer housing section 11, through openings 13b and 13c in the two liners, and through an off-center threaded insert 13d.

The outer housing section 11 defines, with the two inner liners 12, a housing assembly of generally rectangular configuration having a top wall 10a, a bottom wall 10b parallel to the top wall, front and back walls 10c, 10d perpendicular to the top and bottom walls, and a pair of side walls 10e, 10f. Side wall 10e is also perpendicular to the top and bottom walls, but side walls 10f converges towards side wall 10e in the direction from the top to the bottom of the housing.

The inner confronting faces of the two liners 12 are formed with recesses 14 which together define a socket 14a (FIG. 5) in the top wall 10a of the housing for receiving the respective jaw extension 3a. The two liners 12 are also formed with semi-cylindrical recesses 15 adjacent and parallel to the bottom wall 10b, which recesses together define a socket aligned with two horizontal access openings 15a in side walls 10e, 10f of the housing for receiving a contact point rod 30 (FIG. 2) and for clamping the rod in a horizontal position. The two liners are further formed on their confronting faces with semi-cylindrical recesses 16 adjacent and parallel to side wall 10e of the housing, which recesses together define a vertical access opening 16a aligned with a corresponding access opening (not shown) in the housing bottom wall 10b for receiving and clamping another chosen accessory in a vertical position, as will described below.

Housing 10 is firmly clamped to its calipers jaw extension 4a by a pair of thumb knobs 17 each passing through a threaded insert or tendon 17a, respectively, in back wall 10d of the housing, and a third thumb knob 18 passing through a threaded insert or tendon 18a in side wall 10f of the housing. A contact point rod 30, or other accessory, received within horizontal access opening 15a of the housing, and/or the vertical access opening in the housing aligned with access opening 16a in the liners, is clamped in place by a fourth thumb knob 19 passing through a threaded insert or tendon 19a in front wall 10c of the housing and bearing against a pressure pad 19b. Pad 19b acts to firmly clamp the contact point rod, or other accessory, within either or both of the access openings 15a, 16a.

Housing side wall 10d is further formed with a circular recess 10g for receiving a nameplate 10h.

As indicated above, the second housing 20 is of the same construction as housing 10, but each of the above parts is the mirror image of the corresponding part in housing 10.

As shown in FIG. 2, the illustrated extension kit includes, in addition to housings 10 and 20, a plurality of contact point rods 30 (only two of which are shown in FIG. 2), each formed with a threaded bore 30a at one end for threadedly receiving a selected contact point according to the respective application. FIG. 2 illustrates, for purposes of example, two pairs of such contact points 31 and 32. Each contact point of pair 31 is formed with a needle tip 31a at one end, and a threaded shank 31b at the opposite end for threading into bore 30a of its respective contact point rod; and each contact point of pair 32 is formed with a ball tip 32a at one end, and a threaded shank 32b at the opposite end for threading into bore 30a of a contact point rod. The contact points preferably have ribbed or knurled shanks to facilitate their application to, and removal from, a contact point rod 30.

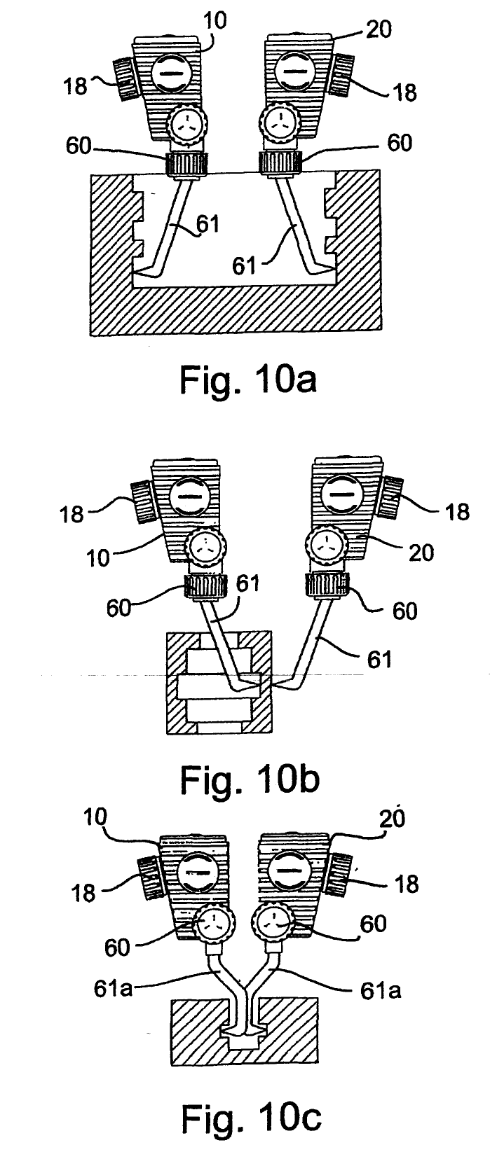

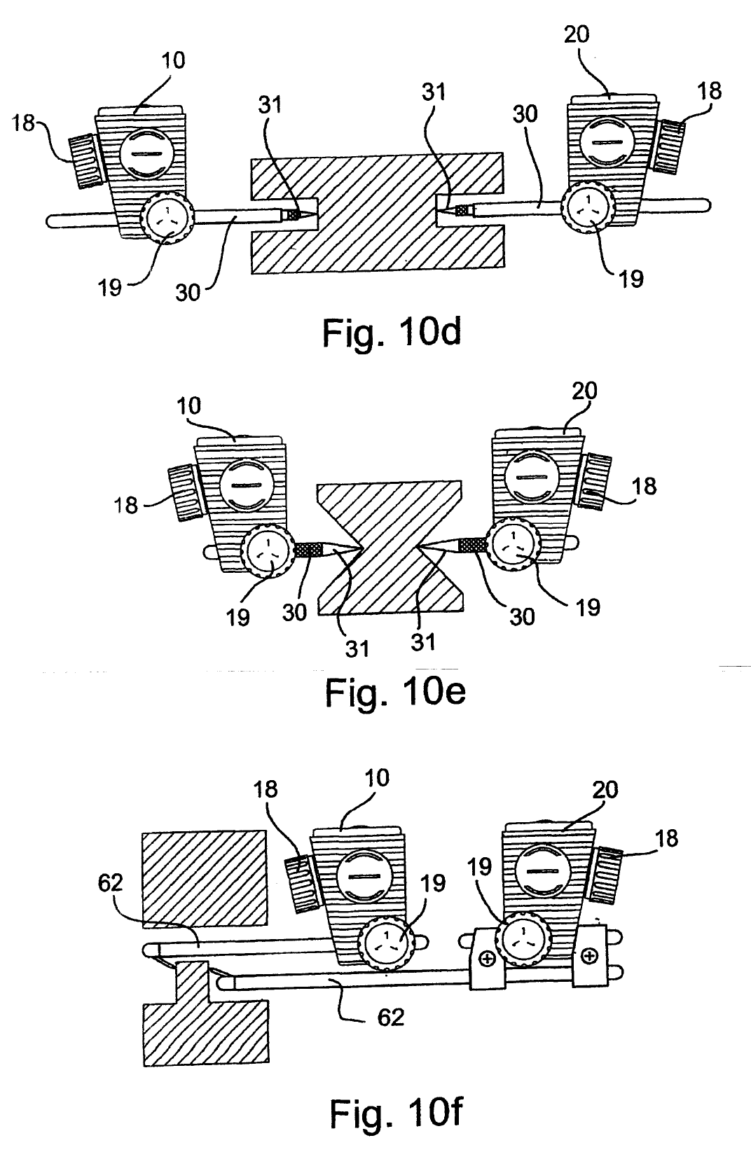

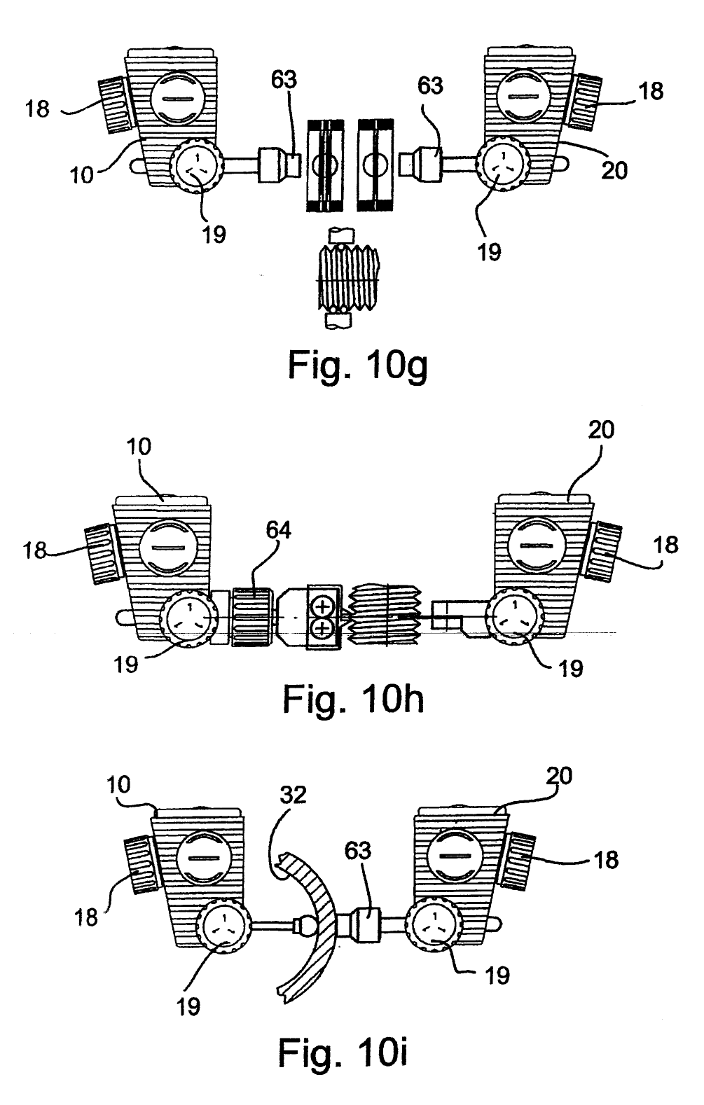

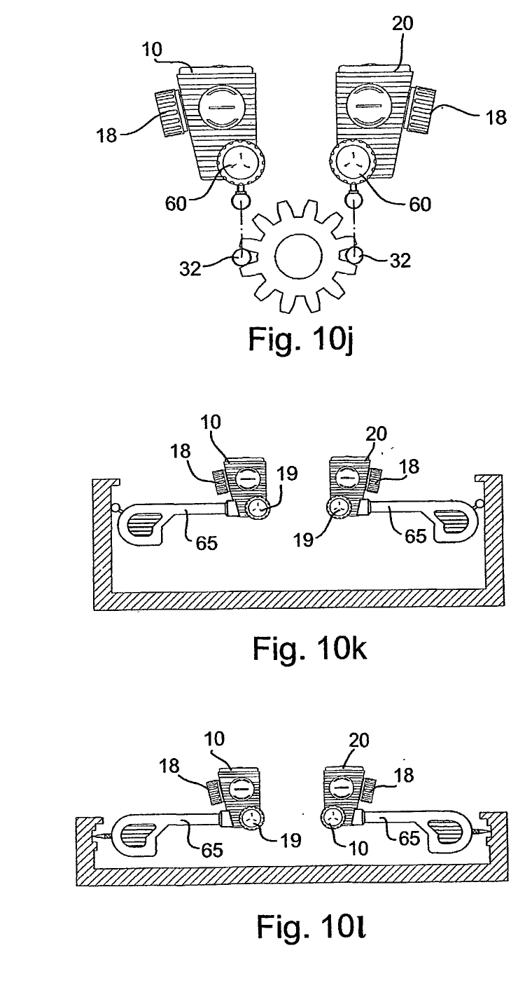

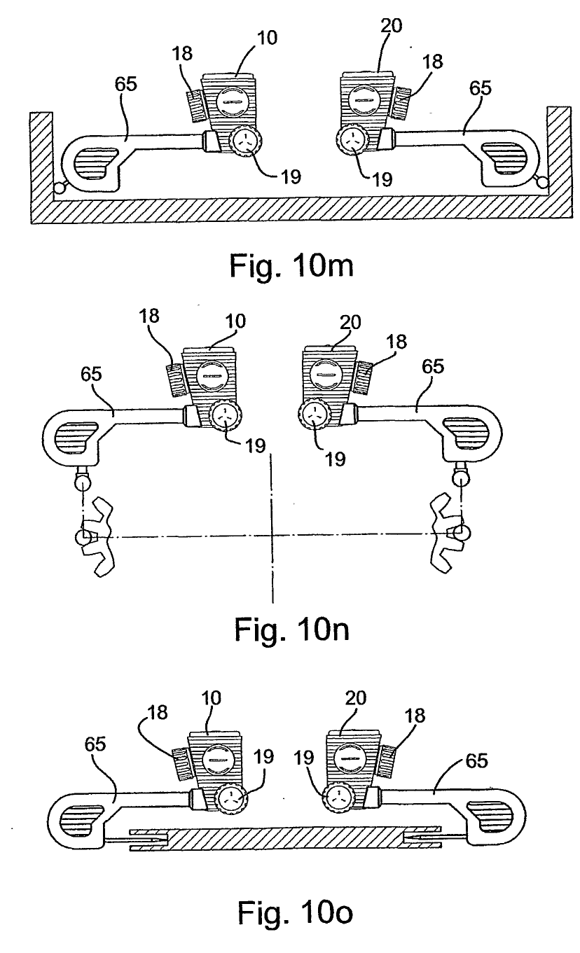

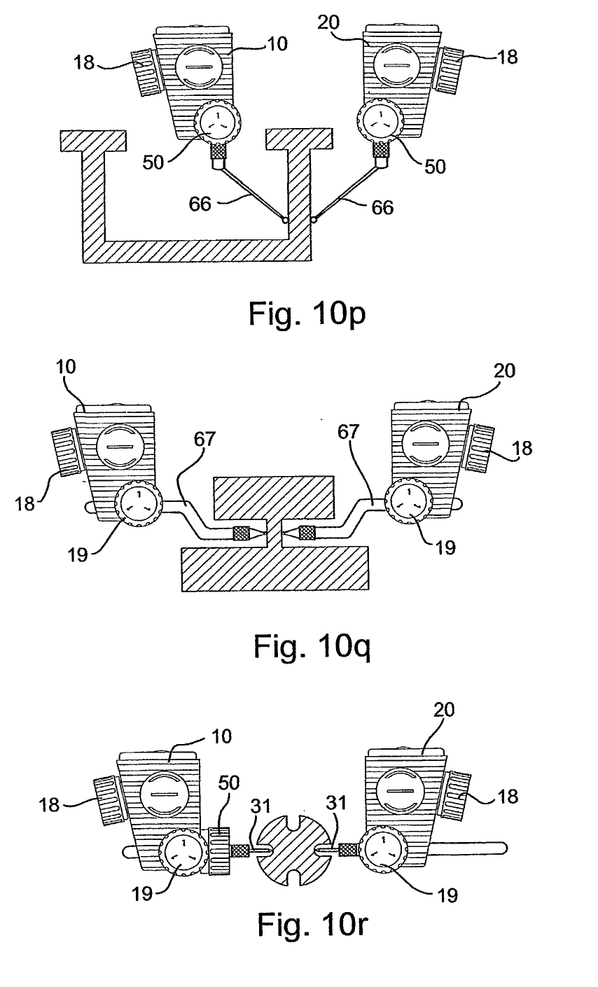

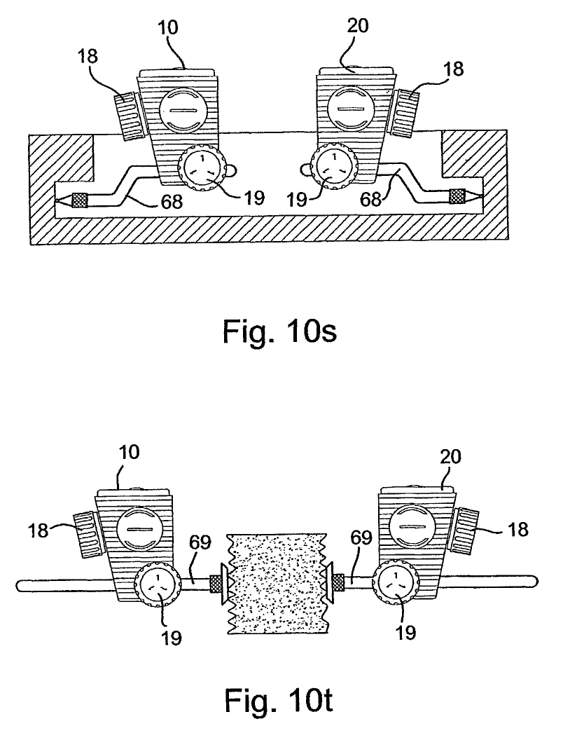

The kit may be provided with a large number of other types of rods and contact points, as well as many other types of accessories, according to the measuring application required in any particular case. FIGS. 10a-10t illustrates other types of rods, contact points, and accessories that may be included or that may be otherwise available for particular applications, as will be discussed below with respect to these figures.

The illustrated extension kit also includes an alignment rod 40 (FIGS. 2 and 9) receivable within the horizontal access openings 15a and recesses 15 of the two houses 10, 20, for aligning the two housings during mounting onto the caliper jaw extensions 3a, 4a.

The extension kit further includes an alignment compensation member, generally designated 50 in FIG. 2, and more particularly illustrated in FIG. 6. Thus, as shown in FIG. 6, member 50 includes a rod 51 at one end receivable within a horizontal access opening 15aof the housings 10, 20, and a ball socket 52 at its opposite end for receiving a ball 53 clamped to rod 51 by a nut 54. The opposite end of ball 53 is formed with a threaded bore 55 for receiving a selected contact point.

The extension kit may also include similar pivotal members and other accessories for use as required by the application. Other types of contact points and/or rods can also be applied for different measuring applications, as described below with respect to FIGS. 10a-10t.

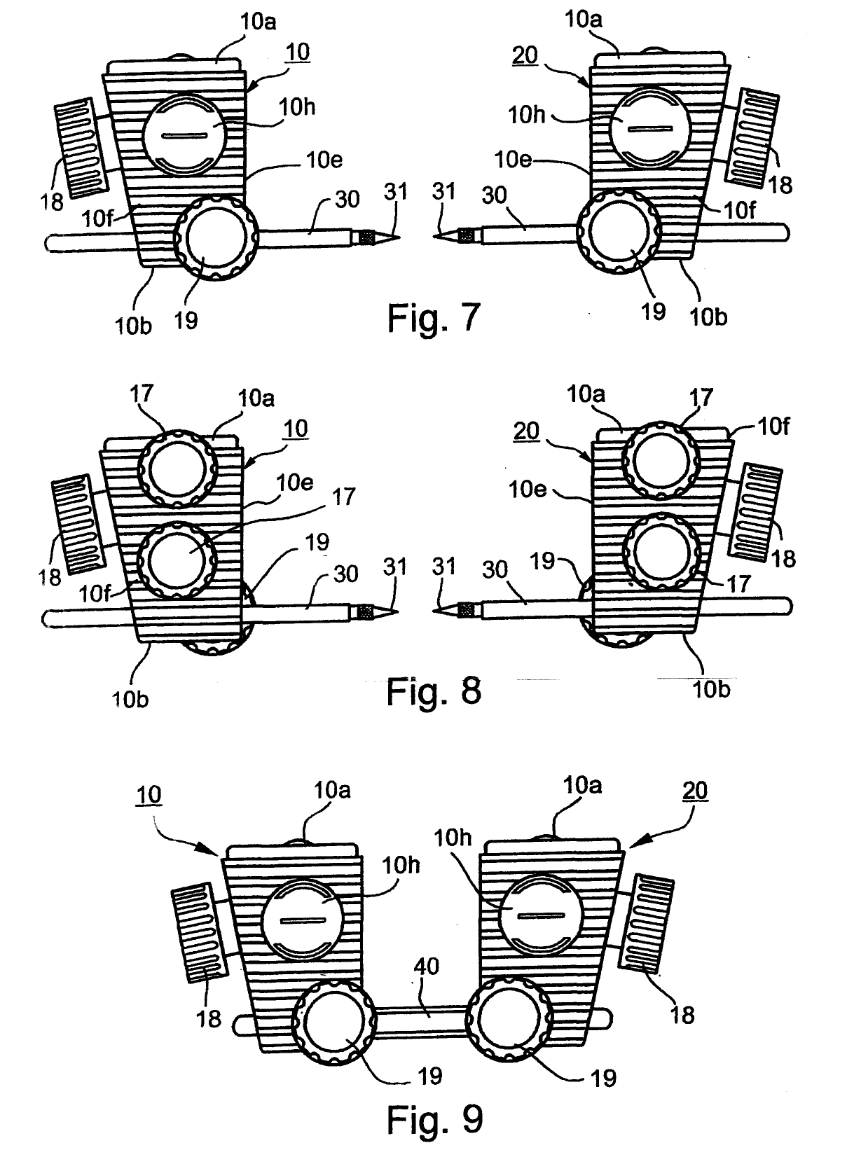

The manner of using the extension kit will be apparent from the above description and also from FIGS. 7-9 and 10a-10t of the drawings.

Thus, the two housings 10 and 20 are first attached to their respective jaw extensions 3a, 4a (FIG. 1) by inserting those extensions through the socket 14a in the top Z,999 alignment rod 40, and is clamped in place by thumb knob 19. FIGS. 7 and 8 are front and rear views, respectively, showing rods carrying needle contact points 31 e.g., for measuring the thickness of a body. Thus, when measuring thickness, the needle point carried by housing 10 clamped to the fixed jaw 4 of the calipers is brought into engagement with one face of the body, and then jaw 3 of the calipers is moved towards jaw 4 until the needle point carried by housing 20 fixed to jaw 3 engages the opposite face of the body. The distance between the two needle points thus represents the thickness of the body.

If the two needle points are not in perfect alignment, such misalignment may be compensated for by the use of member 50 as an alignment compensator. For this purpose, the rod end 51 of member 50 is clamped in the horizontal access openings 15a of the respective housing. The contact point is then threaded into the threaded bore 55 of member 50 and is pivoted to precisely align it with the contact point carried by the housing on the other jaw.

The kit may also include additional members for use in certain measuring applications. FIGS. 10a-10c illustrate two such members 60, 61. Member 60 is a pivotal member similar to the pivotal alignment compensator 50. It has a rod end which is received within the vertical access opening 16a defined by the semi-cylindrical recesses 16 in the two liners 12 of the respective housing and firmly clamped to the housing by thumb knob 19.

The opposite end of the rod includes a pivotal socket. Member 61 is an angled extension rod received in the pivotal socket of member 60.

FIG. 10a illustrates a set up for measuring the inside diameter of a cavity; FIG. 10b illustrates a similar set up for measuring the thickness of a wall defining a cavity; and FIG. 10c illustrates a similar set up, but using a double-angled rod 61a, for measuring recesses within small bores.

FIGS. 10d and 10e illustrate set ups similar to that of FIGS. 7 and 8 using the horizontal access openings 15a for measuring the thickness of an otherwise inaccessible wall; FIG. 10f illustrates a set up including contact point rods 62 for making measurements which would otherwise be difficult or impossible because of an overlying obstruction; FIG. 10g illustrates the use of floating anvil contacts 63 removable in the horizontal access openings 15a for the purpose of measuring screw threads by the known three-wire method; FIG. 10h illustrates the use of adjustable template fittings 64 for comparison measurements of the effective diameter of screw threads; FIG. 10i illustrates the use of a ball contact point 32 and a floating anvil contact 63 for measuring a curved surface; and FIG. 10j illustrates the use of ball contact points 32 mounted in the vertical access openings 15a for making various measurements with respect to gears.

FIGS. 10k-10o illustrate the use of capacity extenders 65 for extending the measuring capacity of the calipers and for using them in making other types of measurements that would otherwise be impossible with conventional calipers; FIG. 10p illustrates the use of commercially-available lever points 66 for measuring otherwise inaccessible dimensions; FIGS. 10q and 10s illustrate the use of joggled contact point rods 67 received in the horizontal access openings 15a and fitted with suitable contact points for making other types of measurements; FIG. 10r illustrates the use of an alignment compensation member 50 mounted in the horizontal axis hole 15a of one housing and a contact point rod 30 carrying a needle point 31 mounted in the other housing for making other measurements; and FIG. 10t illustrates side-mounted rods 69 including flat increased-area contact points for making measurements particularly with respect to soft materials.

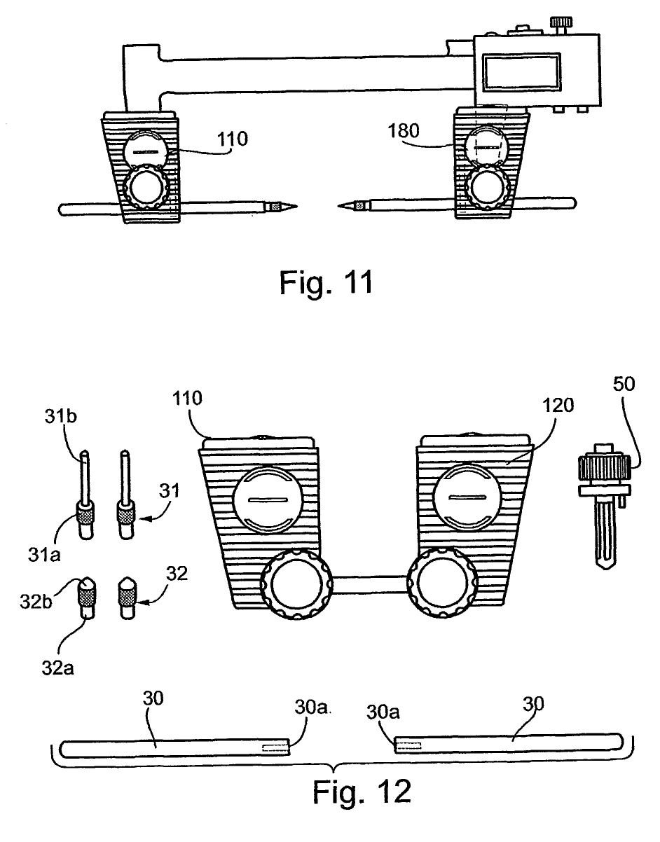

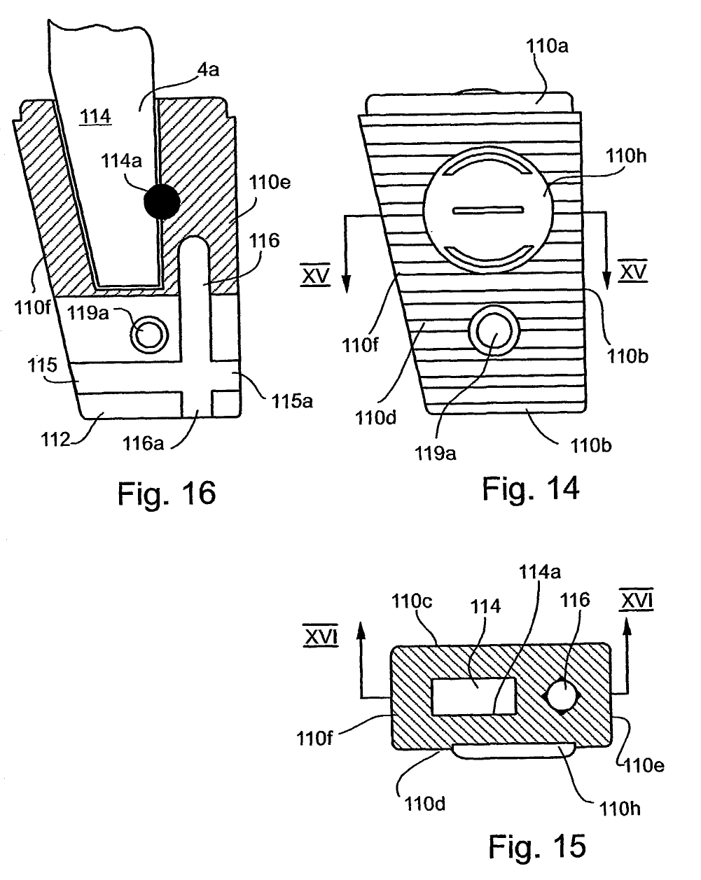

The Kit of FIGS. 11-16

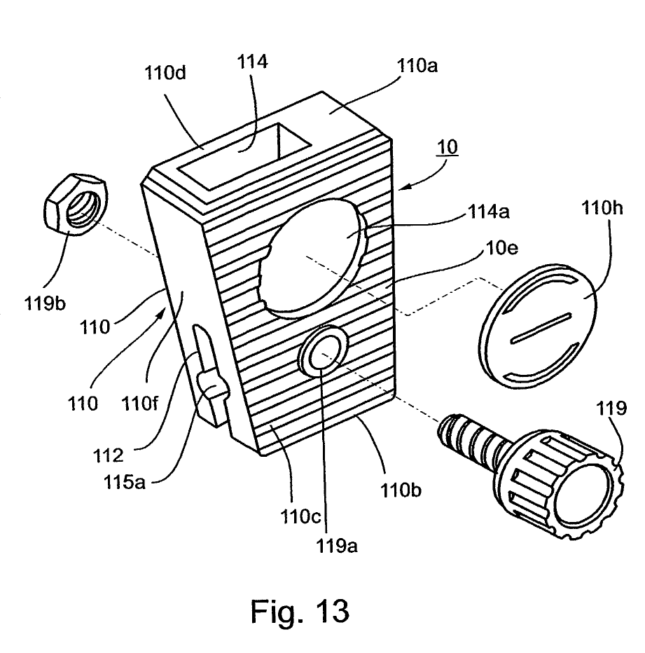

The kit illustrated in FIGS. 11-16 is basically the same as described above, except that it includes a simplified structure of the housings, therein designated 110, 120. The main differences, as shown particularly by comparison of FIGS. 3 and 13, are the elimination of the liners 12 and the thumb knobs 17 for fixing the housings to their respective caliper jaw extensions; instead, each housing is integrally formed with its respective caliper jaw extension 3a, 4a (FIG. 11), as by being injection-molded directly onto its respective caliper jaw, or by being adhesively bonded thereto. The structure of the housings 110, 120 is also modified with respect to the clamping arrangement for clamping the accessories by the thumb knob 119 passing through the front wall of each housing.

FIG. 13 illustrates the construction of housing 110, it being appreciated that housing 120 is similarly constructed but as a mirror image, as in the embodiment described above with respect to FIGS. 1-9.

Thus, as shown in FIG. 13, housing 110 includes a top wall 110a, a bottom wall 110b, a front wall 110c, a back wall 110d, and side walls 110e, 110f. The top wall 110a is formed with a socket 114 for receiving the respective caliper jaw extension 4a; the two side walls 110e, 110f are formed with the horizontal access openings 115a for selectively receiving an accessory; the bottom wall 110b is formed with the vertical access opening 116a (FIG. 16) for selectively receiving an accessory; and the front wall 110c is formed with an opening 119a for threadedly receiving the thumb knob 119, and also with a circular recess for receiving the name plate 10h. The back wall 110d carries a nut 119b for threadedly receiving the end of the thumb knob 119.

As further shown in FIG. 13, and more particularly in FIG. 16, housing 110 includes a rounded plastic projection 114a projecting into the socket 114 to firmly lock the housing to the respective caliper jaw extension 4a, when injection molded therewith or when adhesively bonded thereto, e.g., by an epoxy resin.

In addition, the lower portion of housing 110 is formed with a vertical slot 112 passing through its bottom wall 110b, and partially through its side walls 110e, 110f, to intersect both the horizontal access openings 115a, and the vertical access openings 116a. The semi-cylindrical grooves 115 and 116 aligned with these access openings for gripping the accessories when mounted therein, which access openings were formed in the liners 12 in the embodiments of FIGS. 1-10t, are now formed in the inner surfaces of the housing 110 on opposite sides of the slot 112.

It will thus be seen that when an accessory is received within either of these access openings, rotating thumb knob 119 through its opening 119a in the front wall 110c will tighten it with respect to its nut 119b in the back wall 110d to firmly clamp the accessory in its respective opening.

In all other respects, the extension kit illustrated in FIGS. 11-16 may include the same components and the same construction, and may be used in the same manner, as described above with respect to FIGS. 1-9 and in FIGS. 10a-10t.

While the invention has been described with respect to two preferred embodiments, it will be appreciated these are set forth merely for purposes of example, and that many other variations, modifications and applications of the invention may be made. For example, the housings could be attached to the caliper jaws by a friction fit. Other variations will be apparent.

What is claimed is:

1. An extension kit for extending the use of standard calipers to a wide variety of measuring applications not otherwise possible or convenient for such calipers, which calipers include a slideable jaw slideable along a scaled beam with respect to a fixed jaw, said extension kit comprising:
a first housing attachable to said fixed jaw;
a second housing attachable to said slideable jaw;
and a plurality of accessories including contact point rods selectively attachable to said first and second housings.

2. The kit according to claim 1, wherein each of said housings includes a socket for attaching its respective jaw, and a horizontal access opening for attaching a contact point rod or other suitable accessory.

3. The kit according to claim 2, wherein said kit further includes an alignment rod having its opposite ends receivable in said horizontal access openings of the two housings for preliminarily aligning the two housings.

4. The kit according to claim 2, wherein said kit further includes an alignment compensator comprising a rod at one end receivable in one of said access openings of a housing, a threaded bore at the opposite end for receiving a contact point, and a rotatable ball between said ends for permitting angular adjustment of two opposing contact points.

5. The kit according to claim 2, wherein each of said housings further includes a vertical access opening for attaching another accessory.

6. The kit according to claim 5, wherein said vertical and horizontal access openings have axes located at right angles to each other.

7. An extension kit for extending the use of calipers to a wide variety of measuring applications, which calipers include a first jaw slideable with respect to a fixed jaw along a scaled bar indicating the distance of the slideable jaw from the fixed jaw; said extension kit including:
first and second housings attachable to said slideable and fixed jaws, respectively;
and a plurality of contact point rods carrying a variety of contact points at one of their ends;
each of said housings having a socket for attaching to its respective caliper jaw, and a horizontal access opening for receiving and clamping a contact point rod or other suitable accessory;
said horizontal access openings of the two housings being located in a wall of the respective housing such that when the two housings are attached via said sockets to their respective jaws, said horizontal access openings are substantially aligned with each other.

8. The kit according to claim 7, wherein each of said sockets is formed in the top of the respective housing, and each of said horizontal access openings is formed in a side of the respective housing.

9. The kit according to claim 8, wherein each of said housings is also formed with a vertical access opening in the bottom of the respective housing.

10. The kit according to claim 9, wherein said horizontal and vertical access openings are located at right angles to each other.

11. The kit according to claim 9, wherein said kit further includes an alignment compensator comprising a rod at one end receivable in one of said access openings of a housing, a threaded bore at the opposite end for receiving a contact point, and a rotatable ball between said ends for permitting angular adjustment of a contact point in said threaded bore.

12. The kit according to claim 9, wherein said kit further includes an alignment rod having its opposite ends receivable in said horizontal access openings of the two housings for aligning the two housings.

13. The kit according to claim 9, wherein said first and second housings are of the same configuration and include top and bottom walls, a first pair of opposed side walls, and a second pair of opposed side walls; said sockets being formed in the top walls; said horizontal access openings being formed in side walls; said vertical access openings being formed in the bottom walls.

14. The kit according to claim 13, wherein: said top and bottom walls are parallel to each other, said first pair of opposed side walls are parallel to each other, one of said second pair of opposed side walls is perpendicular to said top and bottom walls and includes said horizontal access opening, and the other of said second pair of opposed side walls converges towards said one side wall of the second pair in the direction from the top walls to the bottom wall and is also formed with said horizontal access opening.

15. The kit according to claim 7, wherein said kit further includes capacity extenders receivable in said horizontal access openings for extending the measuring capacity of the calipers.

16. The kit according to claim 7, wherein said kit further includes floating anvil contacts receivable in said horizontal access openings for measuring screw threads.

17. The kit according to claim 7, wherein each of said housings includes opposed inner liners formed with first recesses of a configuration corresponding to the jaw to be received therein, and with second recesses of a configuration corresponding to the contact point rod to be received therein.

18. The kit according to claim 7, wherein each of said housings is attachable to its respective caliper jaw by threaded knobs.

19. The kit according to claim 7, wherein each of said housings is integrally bonded to its respective caliper jaw by injection molding or by adhesive.

20. The kit according to claim 7, wherein each of said housings includes a top wall, a bottom wall, front and back walls, and side walls; said top wall being formed with said socket; said side walls being formed with said horizontal access openings; said side walls and said bottom wall being formed with slots intersecting said horizontal access openings; and said front wall receiving a threaded knob threaded into a nut carried by said back wall for securely clamping an accessory when received within said horizontal access openings.
